(19) United States
(12) Patent Application Publication
(10) Pub. No.: US 2015/0265971 A1
(43) Pub. Date: Sep. 24, 2015

(54) PERVAPORATION MEMBRANE SEPARATION METHOD

(71) Applicant: HITACHI ZOSEN CORPORATION, Osaka-shi (JP)

(72) Inventors: Suguru FUJITA, Osaka-shi (JP); Shiro INOUE, Osaka-shi (JP); Yoshihiro ASARI, Osaka-shi (JP); Yoshinobu TAKAKI, Osaka-shi (JP)

(73) Assignee: HITACHI ZOSEN CORPORATION, Osaka-shi (JP)

(21) Appl. No.: 14/711,186

(22) Filed: May 13, 2015

Related U.S. Application Data
(63) Continuation of application No. 13/395,297, filed on Mar. 9, 2012.

(30) Foreign Application Priority Data
Sep. 11, 2009 (JP) 2009-210496

(51) Int. Cl. B01D 61/36; B01D 69/04; B01D 63/06

(52) U.S. Cl. CPC B01D 61/362; B01D 63/06; B01D 69/04; B01D 2313/10; B01D 2313/12

(57) ABSTRACT

To reduce an influence of concentration polarization in a simple structure without an outer membrane element 32 and baffles, reduce a manufacturing cost of a module, and reduce a risk of damaging a membrane surface during manufacture. A plurality of horizontal cylindrical membrane elements 32 are disposed to form a row in a vertical direction in a module main body 11. An inside of each of the membrane elements is depressurized. A treatment liquid is sprayed from above the uppermost membrane element 32 so as to form a falling liquid membrane on outer faces of the respective membrane elements 32.

### CROSS-REFERENCE TO RELATED APPLICATIONS

This application is a continuation of U.S. patent application Ser. No. 13/395,297, which is the National Stage of the International Patent Application No. PCT/JP2010/064772, filed Aug. 31, 2010, the disclosures of which are incorporated herein by reference in their entireties. This application claims priority to Japanese Application No. 2009-210496, filed Sep. 11, 2009.

### TECHNICAL FIELD

The present invention relates to a pervaporation membrane separating module and specifically to a pervaporation membrane separating module effectively applied to dewatering and anhydration of a water-containing organic substance such as anhydration for converting bioethanol into ethanol as automobile fuel, regeneration of high-purity solvent used for cleaning or dewatering and drying in a manufacturing process of a semiconductor or liquid crystal, removal of water as an impure substance included in organic liquid used as a raw material for producing various chemical products and drugs, removal of by-product water which is produced by a reaction represented by an esterification reaction, accumulates in a product, and hinders completion of the reaction, as one of representative examples of newsworthy anhydration of a water-containing organic substance. The PV membrane separation is expected to be more widely applied to many fields besides permeation and removal of water.

### BACKGROUND ART

A membrane separation technique is applied more and more widely in various industrial treatment processes. An important key to obtaining a more efficient membrane separation process is employment of a module structure which can make full use of features of advanced membrane elements.

A PV (pervaporation) membrane dewatering process for removing water from a water-containing organic substance is an important field to which industrial membrane separation is applied. An important key to making use of advanced membrane performance is provision of a module structure which minimizes an influence of concentration polarization formed near a membrane surface on a side of supplied liquid.

The concentration polarization is a phenomenon in which a concentration of solute on the membrane surface on a side of a raw material liquid becomes higher than a solute mixture average concentration in a flow path on the side of the raw material liquid, which reduces propulsion of membrane permeation of the solute and negatively affects a membrane permeation flux. To avoid this phenomenon, it is necessary to increase a mass transfer velocity between a main flow and the membrane surface on the side of the raw material liquid. In a conventional PV module, a flow on the side of the raw material liquid is a single liquid phase flow filling and flowing through a flow path. Conceivable methods of increasing the mass transfer velocity are (1) to increase a flow velocity of the flow on the side of the raw material liquid, (2) to form a structure which facilitates turbulence and mixture in the main flow, and the like, and the method (1) which does not require a complicated structure is employed in general.

Conventionally, in the PV membrane separation using tubular membrane elements, a double tube module and a shell and tube module with baffles are used.

As shown in FIG. 5, the double tube module includes a horizontal cylindrical module main body 101 and a plurality of double tubes 102 arranged to form a row in a vertical direction in the module main body 101. Each double tube 102 includes a horizontal cylindrical membrane element ill forming an inner tube and a duct 112 forming an outer tube and forming a fluid passage P around each membrane element. At a left end of a body wall of the module main body 101, a supplied fluid inlet 121 is disposed downward and a dewatering fluid outlet 122 is disposed upward. A permeation vapor outlet 123 is formed at a center of a right end wall of the module main body 101. Each membrane element 111 has a closed left end and an open right end. The duct 112 has a closed left end and a closed right end through which a right end portion of the corresponding membrane element 111 passes. The ducts 112 adjacent to each other in the vertical direction communicate with each other so as to form a meandering fluid passage in the entire duct 112 from the supplied fluid inlet 121 to the dewatering fluid outlet 122. The lowermost duct 112 communicates with the supplied fluid inlet 121 and the uppermost duct 112 communicates with the dewatering fluid outlet 122.

This module can make best use of the performance of the membrane elements 111 by reliably maintaining the membrane surface flow velocity to minimize the concentration polarization. However, if the flow velocity of the liquid on the side of the raw material flowing through an annular flow path P is increased, a flow path length needs to be increased (because lengths of the membrane elements 111 are fixed, it is necessary to increase the flow path length by connecting the membrane elements 111 in series by some method. If the double tubes 102 are housed in the module main body 101, the number of paths is increased), and the number of metal tubes used for the outer tubes which are the ducts 112 is large.

As shown in FIG. 6, the shell and tube module with the baffles includes a horizontal cylindrical module main body 201 and a pair of left and right tube bundles 202 housed in the module main body 201. A vertical left tube plate 203 is provided near a left end wall in the module main body 101, and a left separation vapor chamber 204 is formed at the left of the plate 203. A vertical right tube plate 205 is provided near a right end wall in the module main body 201 and a right separation vapor chamber 206 is formed at the right of the plate 205. A supplied fluid inlet 207 is provided to a body wall of the module main body 201 near the right tube plate 205 and a downward dewatering fluid outlet 208 is provided to the body wall near the left tube plate 203, respectively. Each of the tube bundles 202 includes a plurality of membrane elements 211 arranged to form rows in vertical and front-back directions. One ends of the membrane elements 211 of each of the tube bundles 202 communicate with the corresponding separation vapor chamber 204 or 206, and the other ends are closed. So as to form a meandering fluid passage P from the supplied fluid inlet 207 to the dewatering fluid outlet 208, a plurality of vertical plate-shaped baffles 212 are provided between the left and right tube plates 203 and 205.

The left and right separation vapor chambers 204 and 206 are respectively provided with permeation vapor outlets 221 and 222 and connected to vacuum systems via condensers.

This module does not require the above-described outer tubes. In order to increase the flow velocity of the raw material liquid in the module main body 201, a large number of baffles 212 are used. It is still difficult to secure an ideal membrane surface flow velocity, and the concentration polarization tends to have a large influence. Furthermore, during manufacture of the module, it is necessary to insert the membrane elements 211 through holes formed in the large number of baffles 212 in mounting the membrane elements 211 in the module main body 201. The tubular PV membrane such as a zeolite membrane has a delicate surface and the surface may rub against edges of the holes while passing through the holes in the baffles 212, which highly likely to damage the membrane.

In the double tube module described above, a performance confirmation test was carried out and the following result was obtained. For the test, a testing machine made up of only two membrane elements continuous from a supplied fluid inlet side was used.

Focusing attention on the second (subsequent stage) membrane element 111 from the supplied fluid inlet 121, condition setting and performance confirmation were carried out. The tubular PV membrane element ill was an A-type zeolite membrane having an outer shape of 17 mm and an effective length of 1 m. The supplied fluid was an aqueous solution of ethanol of an average concentration of 95 wt. % at an inlet and an outlet of the second membrane element 111. Although an amount of the supplied fluid was 100 L/h, such an amount of treatment liquid is in a range of a condition often encountered in practical use such as an in-plant dewatering and refining treatment of a solvent for cleaning and drying electronic parts. In order to maximize a flow velocity in an annular portion, a stainless tube having an outer diameter of 27.2 mm and an inner diameter of 21.4 mm (a tube wall thickness of 2.9 mm) was selected as the outer tube 112 so as to minimize the inner diameter. In this case, a sectional area of an annular flow path formed by the inner diameter of the outer tube 112 and an outer diameter of the membrane element 111 was 1.33 cm² and an average flow velocity corresponding to a liquid flow rate of 100 L/h was about 0.21 m/sec, which was considered an excessively low flow velocity from a viewpoint of an influence on the concentration polarization.

In order to maximize propulsion in the PV dewatering, an operation pressure on the permeation vapor side was maintained at 1 kPa (abs) by using a condenser and a dry vacuum pump for cooling with a low-temperature refrigerant (0° C.) cooled by a chiller. The temperature of the supplied liquid was maintained at about 75° C. on an average at the inlet and outlet of the second membrane element 111.

The permeation flux under the above-described conditions was measured to obtain a value of about 1.6 Kg/m²·h. Although the operation pressure on the permeation side was minimized to maximize the propulsion of the dewatering, the permeation flux was not satisfactory. After studying this result from various angles, it was found that the influence of the concentration polarization was dominant because the flow velocity in the annular portion was excessively low.

Then, whether the permeation flow velocity would be increased by increasing the flow velocity in the annular portion was checked. The flow velocity in the annular portion was increased by receiving the liquid in a container at the test dewatering fluid outlet 122 and circulating the liquid into the supplied fluid inlet 121 with a pump. If circulation of the liquid is employed in an actual module, the liquid which has been once dewatered is mixed into the supplied liquid to thereby reduce the propulsion for the PV membrane separation. Therefore, even if the influence of the concentration polarization can be reduced, it is difficult to determine which of the positive effect and the negative effect becomes dominant. However, the influence of the flow velocity on suppression of the concentration polarization and increase in the permeation flux was studied here.

When the liquid was circulated and the flow velocity in the annular portion was doubled, the permeation flux was slightly increased to 2.0 kg/m²·h. When a circulated amount was increased substantially to increase the flow velocity by ten-fold in the annular portion, the permeation flux increased to about 3.4 kg/m²·h. When the flow velocity was increased by twenty-fold, the permeation flux increased to about 4.3 kg/m²·h. This shows that the permeation flux increases substantially in proportion to the one-third power of the flow velocity. From these data, the permeation flux presumably dominated the concentration polarization in this case. However, circulation of the large amount of liquid in this manner is hardly practical from viewpoints of both equipment (pump capacity) and running cost and was not determined to be a useful method.

### SUMMARY OF THE INVENTION

### Problems to be Solved by the Invention

Specializing a separation membrane module for a PV method, it is an object of the present invention to provide a pervaporation membrane separating module with a structure in which an outer tube is not used, a baffle is not provided to an intermediate portion, and which avoids a problem of a conventional module.

### Means for Solving the Problems

A pervaporation membrane separating module according to the present invention includes a module main body container, a plurality of external pressure tubular pervaporation membrane elements disposed horizontally to form a row in a vertical direction in the module main body container, an inside of each of the tubular membrane elements being connected to a depressurizing system through a separation vapor chamber, and spray means for spraying a raw material liquid from above the uppermost membrane element so as to form a falling liquid membrane on outer faces of the respective membrane elements.

In the present invention, the tubular membrane elements for permeation from outside into the tubes (herein, referred to as “external pressure type” for short) are mounted horizontally in the module main body to forma tube bundle and a problem in a conventional module is avoided without using an outer tube and without providing a baffle at an intermediate portion. A structure for spraying the liquid onto the tube bundle is provided, the raw material liquid is sprinkled on the tube bundle, the surfaces of the tubular membrane elements get wet with the raw material liquid, and an extremely thin liquid membrane is formed. The liquid which has wetted the membrane surface of the uppermost tubular membrane element successively flows down onto the lower tubular membrane elements, and the raw material liquid forms an extremely thin liquid membrane on outer surfaces from the uppermost membrane element to the lowermost membrane element, and flows downward from above. Inside all the tubular membrane elements, partial pressure of the permeating fluid is reduced by means of depressurization or the like (which is the same as in the conventional module) and therefore, in a process of flowing downward from above of the raw material liquid while forming the liquid membrane, permeation of the target substance such as water to be removed proceeds, and concentration and refinement of the raw material liquid proceed. The greatest features are that mass transfer between a raw material liquid main flow and a PV membrane surface is facilitated by forming the extremely thin liquid membrane of the raw material liquid, and that an influence of concentration polarization can be reduced with a simple structure without an outer tube and a baffle, which reduces manufacturing cost of the module and reduces a risk of damaging the membrane surface during manufacture.

### Effects of the Invention

Greatest features of the present invention are that an influence of concentration polarization can be reduced with a simple structure without an outer tube and a baffle, which reduces a manufacturing cost of a module and reduces a risk of damaging a membrane surface during manufacture, because a membrane flow velocity is increased and a concentration boundary layer is reset every time a liquid moves to a lower membrane element by forming an extremely thin liquid membrane of the supplied liquid on outer faces of membrane elements retained horizontally and, as a result, a high mass transfer velocity between the supplied liquid main flow and the surface of the membrane element is maintained.

### BRIEF DESCRIPTION OF THE DRAWINGS

FIG. 1 is a vertical sectional view of a separation membrane module according to the present invention.

FIG. 2 is a conceptual diagram showing a state of a liquid membrane formed on a surface of a membrane element by the separation membrane module.

FIGS. 3A to 3C are conceptual diagrams showing a state of a treatment liquid flowing down the surfaces of the membrane elements.

FIGS. 4A to 4D are explanatory views showing arrangement forms of the membrane elements.

FIG. 5 is a vertical sectional view of a double tube module according to a conventional example.

FIG. 6 is a vertical sectional view of a shell and tube module with baffles according to a conventional example.

### EMBODIMENT FOR CARRYING OUT THE INVENTION

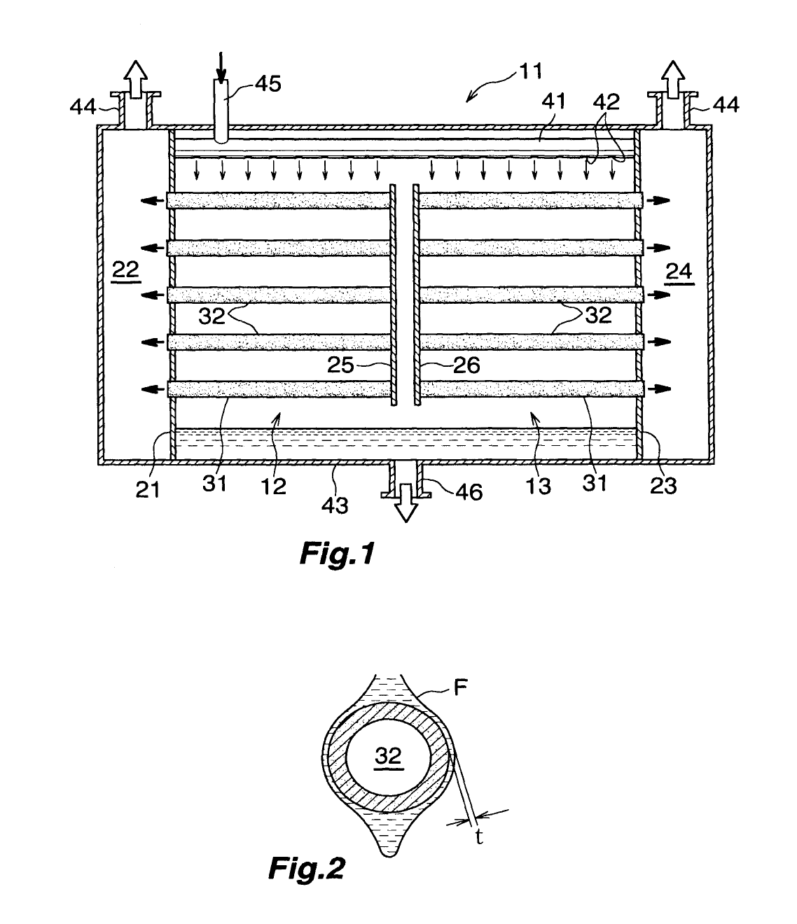

With reference to FIG. 1, a module includes a module main body 11 in a shape of a rectangular parallelepiped which is long in a left-right direction and a pair of left and right membrane element tube bundles 12 and 13 housed in the module main body 11.

Near a left end wall in the module main body 11, a vertical left tube plate 21 is provided. A separation vapor chamber 22 is formed at the left of the left tube plate 21 in the module main body 11. A vertical right tube plate 23 is provided near a right end wall in the module main body 11. A right separation vapor chamber 24 is formed at the right of the right tube plate 23 in the module main body 11. A pair of left and right vertical opposed support plates 25 and 26 is provided at a center in the left-right direction in the module main body 11.

Each of the tube bundles 12 and 13 includes a plurality of membrane element rows 31 arranged in a front-back direction (direction orthogonal to a paper surface of FIG. 1). Each membrane element row 31 includes a plurality of horizontal tubular membrane elements 32 arranged in a vertical direction.

Each membrane element 32 is an external pressure membrane element obtained by forming a zeolite membrane on a surface of a support made of ceramic.

In the left tube bundle 12, each membrane element 32 is fixed like a bridge between the left tube plate 21 and the left support plate 25. A left end of each membrane element 32 is open and communicates with the left separation vapor chamber 22. A right end of each membrane element 32 is closed.

In the right tube bundle 13, each membrane element 32 is fixed like a bridge between the right tube plate 23 and the right support plate 26. A right end of each membrane element 32 is open and communicates with the right separation vapor chamber 24.

Above the left and right tube bundles 12 and 13, there are disposed a plurality of horizontal spray tubes 41 extending in the left-right direction and parallelly arranged in the front-back direction. A plurality of downward spray holes 42 are formed at intervals in a longitudinal direction of each spray tube 41. Below the left and right tube bundles 12 and 13, a pan 43 is disposed.

To each of the separation vapor chambers 22 and 24, a separation vapor exhaust pipe 44 for sending permeation vapor to a condenser (not shown) is connected. To the pan 43, a treatment liquid outlet pipe 46 for sending a treatment liquid to a next module (not shown) is connected.

Through supply pipes 45, a raw material liquid is supplied into the spray tubes 41. The supplied raw material liquid is sprayed through the spray holes 42 on the uppermost membrane elements 32 from above. The sprayed raw material liquid wets outer surfaces of the membrane elements 32 to form falling liquid membranes. Insides of the membrane elements 32 are depressurized through the separation vapor exhaust pipe 44 and the separation vapor chamber 22 or 24 and water included in the raw material liquid forming the liquid membranes permeates through the membrane elements 32 and the raw material liquid is subjected to a concentration treatment.

The raw material liquid sprayed from above the uppermost membrane elements 32 successively flows down from the upper membrane elements 32 to the lower membrane elements 32 to form liquid membranes on the surfaces of the respective membrane elements 32. Since the liquid membranes are extremely thin, a local flow velocity is high despite a small flow rate, and the raw material liquid mixes in the inside of the liquid membrane every time it flows down to the lower membrane element 32 to cancel concentration boundary layers, and therefore a water permeation velocity (permeation flux) per unit surface area of the membrane increases to improve separation efficiency.

The embodiment in the above description is a typical embodiment and the present invention is not entirely restricted to the description. More specifically, the number of the tube bundles 12 and 13 is not necessarily two and only the left or right tube bundle 12 or 13 in FIG. 1 may be used in some cases. The methods of fixing and supporting the membrane elements 32 are not limited to the above methods either. The type of membrane element 32 is not limited to one formed by forming the zeolite membrane on the ceramic support either. With the tubular membrane element which is effective at the PV (pervaporation) membrane separation, the present invention can be carried out without a problem. Furthermore, if the supplied raw material is a liquid at a lower temperature than a boiling point, operation is carried out under the ordinary pressure and therefore the module main body 11 can be advantageously formed in the shape of the rectangular parallelepiped having high capacity efficiency. However, in general, the shape of the container may be determined from viewpoints of a pressure condition and manufacturing cost, and the present invention is not limited to the rectangular parallelepiped module container.

The tubular PV membrane element employed here is what is called the external pressure type, and a layer which is effective at the separation is formed on an outer surface, the raw material liquid is supplied to the outside of the tube of the membrane element under a condition of increased partial pressure of a substance to be caused to permeate (usually in a warmed state). The PV permeation proceeds toward the inside of the tube where a condition of reduced partial pressure of the permeating substance is maintained (usually in a depressurized state), the permeating substance vaporized in the process of membrane permeation passes through the pipe connected to a suction side of the lower-pressure condenser or vacuum pump and is extracted from the inside to the outside of the tube.

The large number of external pressure tubular PV membrane elements described above are mounted to the tube plates so that all the tubes are horizontal to form a tube bundle of horizontal tubes. From the liquid dispersing mechanism provided above the tubular PV membrane element tube bundle, the warmed raw material liquid is supplied to wet all the uppermost tubes.

As the liquid dispersing mechanism, a tray may be disposed, small holes are formed in a bottom plate of the tray along longitudinal directions of center lines of all the uppermost tubes, and the liquid is dropped uniformly while a liquid level of a few centimeters is maintained on the tray. If the raw material includes fine particles and easily clogs the holes in the bottom plate, a nozzle sticking up from the bottom plate may be attached, the raw material liquid is caused to flow into the nozzle while avoiding clogging with the settling fine particles, and the raw material liquid is dropped from a lower end of the nozzle. It is also possible to spray the liquid downward with a spray. As another method, a narrow slit may be formed in the bottom plate in the longitudinal direction of the tube and weir plates having small notches formed at their upper sides may be provided to peripheral edges of the slit, and the liquid flowing over the weir plates may be supplied onto the center of the tube. There are various other methods of dispersing the liquid. However, effects of the invention are not exerted by a specific liquid dispersing method.

FIG. 2 shows an image of a liquid membrane F formed on an upper face of the surface of the membrane element 32.

The raw material liquid supplied onto the membrane element 32 wets the surface of the membrane element 32 and spreads in a longitudinal direction of the membrane element 32 by the action of surface tension. The raw material liquid supplied to an upper end (in a direction of 12 o'clock) of the membrane element 32 flows down toward a lower end (in a direction of 6 o'clock) of the membrane element 32 while forming the thin liquid membrane F on the surface of the membrane element 32 by the action of gravity, and a solvent component to be separated permeates toward the depressurized inside of the membrane element 32 while vaporizing.

The remaining liquid having a slightly increased concentration of a solute component flows down onto an upper end of the next membrane element 32 in a lower position and the same phenomenon as that described above is repeated.

The effectiveness of the present invention is greatly influenced by forming conditions of the liquid membrane F. First, the smaller the thickness t of the liquid membrane F, the more easy the mass transfer between a main flow of the raw material liquid and the surface of the PV membrane becomes. The thickness t of the liquid membrane F is influenced by a tube size, physical properties of the raw fluid material, a flow rate of the supplied liquid per unit length of the tube, and the like. The smaller the flow rate of the liquid per unit length of the tube, the smaller the thickness is. However, if the flow rate of the liquid is excessively small, the liquid membrane F ruptures to form an area where the liquid does not substantially flow on the surface of the pipe. For the use such as anhydration of the solvent, even if an unwet area is formed on the membrane surface, irreversible surface contamination such as deposition of scale does not occur although an effective membrane area is accordingly decreased. However, in order to maintain high treatment efficiency, it is important to maintain the flow rate in such a range as not to cause rupture of the liquid membrane F. If the raw material liquid and the membrane surface have a high affinity for each other as in treatment of the raw material liquid including water with hydrophilic porous membrane, it is possible to reduce the flow rate and make the thickness t of the liquid membrane extremely small without causing the rupture of the liquid membrane F. A condition for obtaining a preferable liquid membrane F not on the premise that the liquid and the membrane surface have a special affinity for each other is 20≦Re_{L}≦200.

Here, Re_{L} is a Raynolds number of the liquid membrane and Re_{L} is defined as 4·m/μ.

In this case, m is a half of the flow rate per unit length of the horizontal tube (the liquid supplied to a top of the tube is divided into two to form the liquid membrane, as shown in FIG. 2) [kg/m·h], and μ is a viscosity of the liquid [kg/m·h]. However, even if the Raynolds number is out of this range, the present invention does not immediately lose its effectiveness.

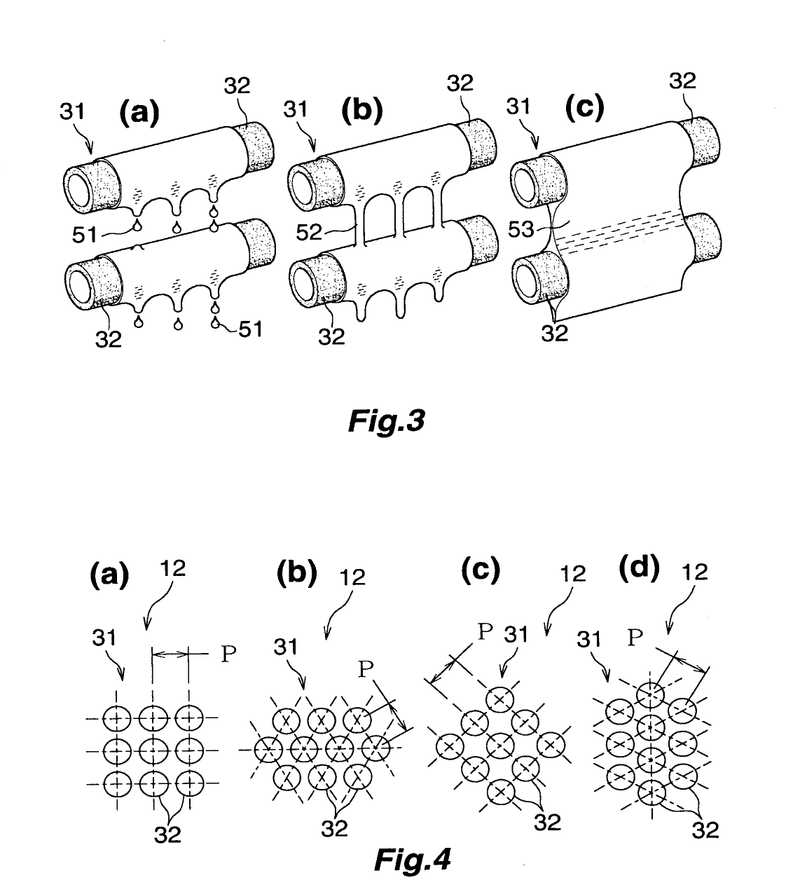

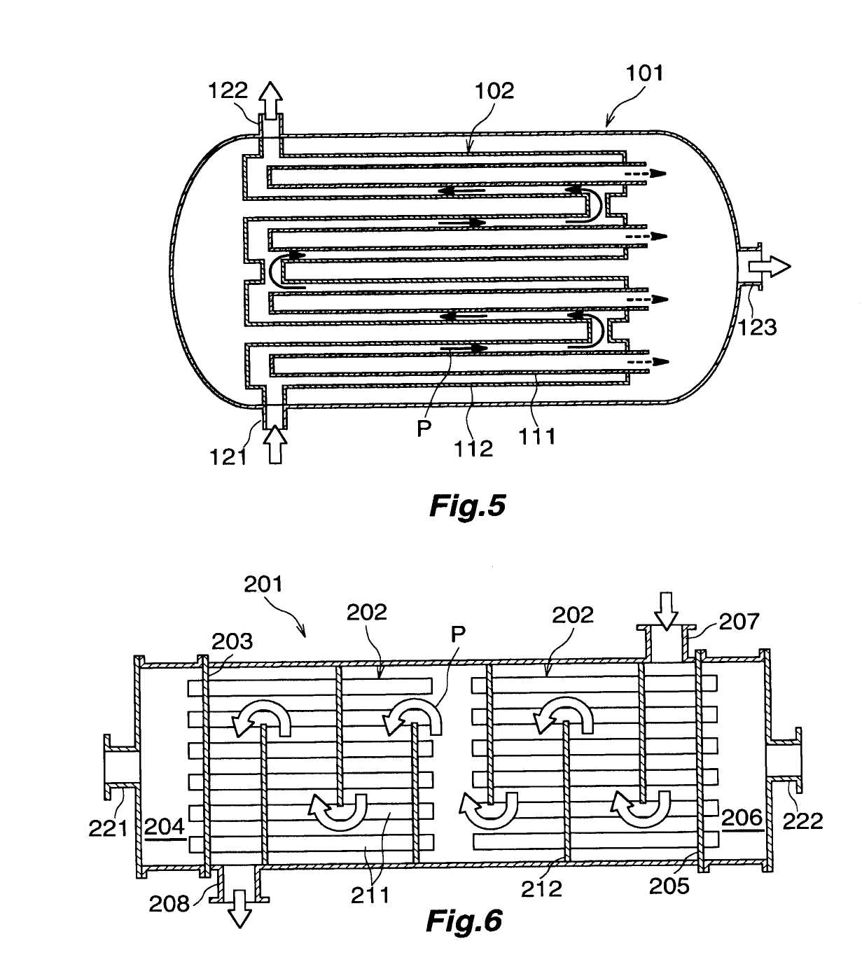

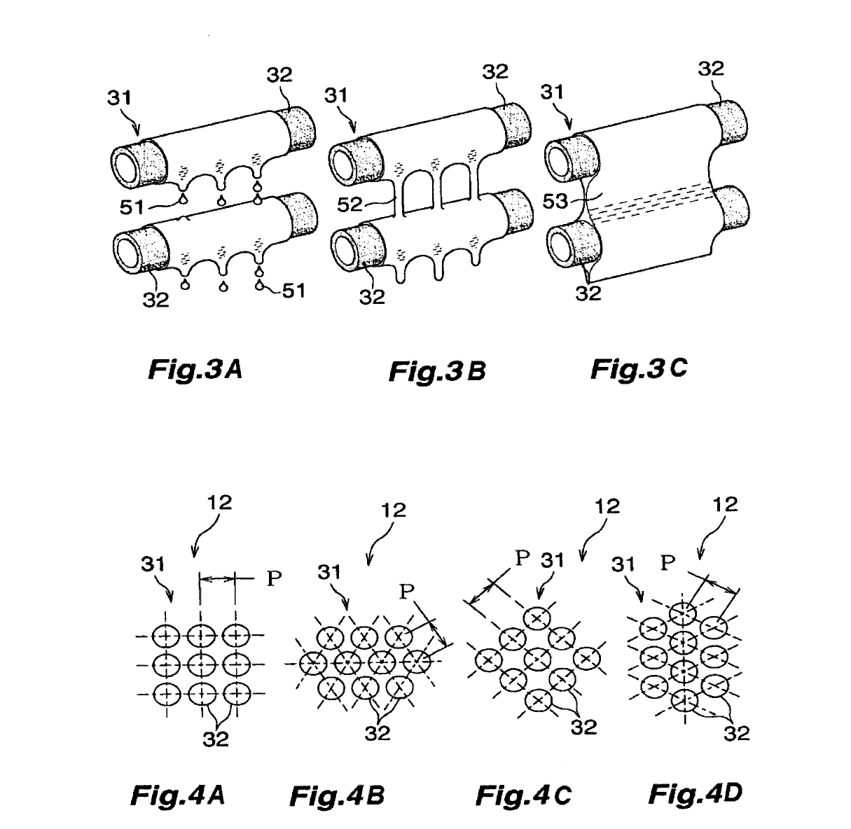

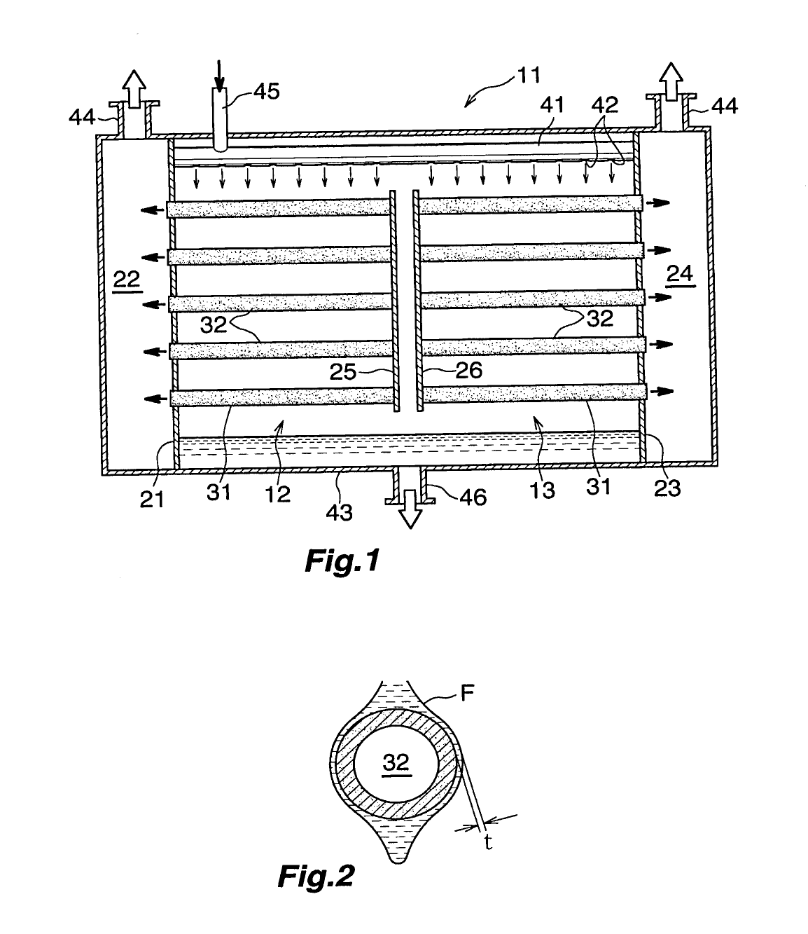

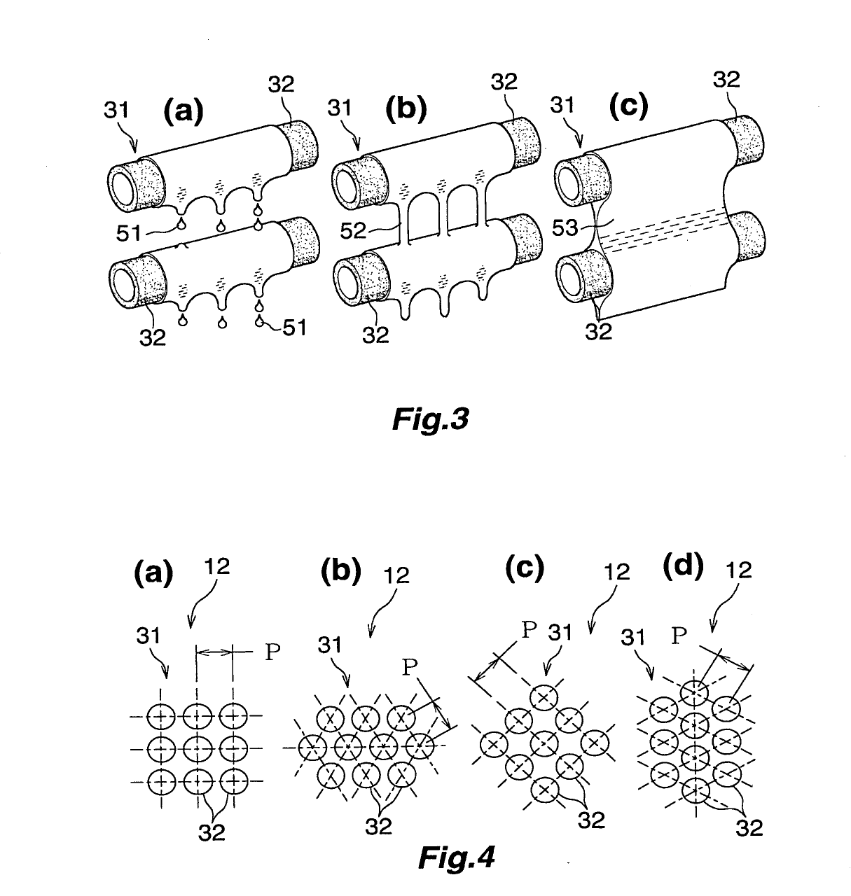

There is another condition for increasing the effectiveness of the present invention. It is necessary to pay attention to a flowing state of the liquid falling between the upper and lower tubes. This flowing state is shown in FIGS. 3A to 3C.

Even under a condition in which the surface of the membrane element 32 is sufficiently wet, if a distance between the upper and lower membrane elements 32 is long, the liquid dropped from a lower end of the upper membrane element 32 turns into large liquid drops 51 and reaches an upper end of the lower membrane element 32 as shown in FIG. 3A. Focusing attention on the uppermost membrane element 32, there is no concentration boundary layer at the upper end of the membrane element 32. However, the PV membrane separation proceeds while the liquid flows down the surface of the membrane element 32 as the liquid membrane and therefore the concentration boundary layer is formed in the liquid membrane. Although the concentration boundary layer remains in the liquid dropping from the lower end of the membrane element 32, the liquid is stirred and mixed in a stagnant portion at the upper end of the membrane element 32 when the liquid flows down in forms of the liquid drops 51 between the upper and lower membrane elements 32 and reaches the upper end of the lower membrane element 32 to form the liquid membrane again, and the concentration boundary layer almost disappears. Therefore, in each of the second and lower membrane elements 32, a new concentration boundary layer starts to be formed from the upper end (in a direction of 12 o'clock) of the membrane element 32 and therefore the average mass transfer velocity on the membrane element 32 is hardly reduced and high performance is exerted irrespective of the number of the membrane elements 32 arranged in the vertical direction.

If the distance between the upper and lower membrane elements 32 is reduced or the flow rate per unit length of the membrane element 32 is increased departing from this condition, the flow between the upper and lower membrane elements 32 comes to a state of liquid columns 52 as shown in FIG. 3B, the stirring and mixture at the portion where the flow reaches the upper end of the lower membrane element 32 weaken, the concentration boundary layer further develops in the liquid membrane of the lower membrane element 32 from the state in which the concentration boundary layer remains at the upper end, and the average mass transfer velocity on the lower membrane element 32 is influenced negatively. If the membrane elements 32 are further brought closer or the flow rate is further increased, the flow of the liquid between the upper and lower membrane elements 32 turns into a continuous sheet 53 as shown in FIG. 3C, the concentration boundary layer becomes more likely to accumulate on the lower membrane element 32, and the mass transfer performance further worsens. Therefore, it is preferable to maintain the flow between the upper and lower membrane elements 32 in the dropping mode shown in FIG. 3A to a maximum extent.

With regard to mode shifting conditions of the liquid flow between the upper and lower membrane elements 32, results of many studies have been reported. For example, in X. Hu and A. M. Jacobi, Transaction of the ASME Journal of Heat Transfer, Vol. 118, August 1996, pp. 616-625, a relationship, Re_{L}=0.0743·Ga^{0.302} is reported as the liquid membrane Raynolds number which is the boundary between the dropping mode and the liquid column mode shown in FIG. 3B.

Here, Ga is a correction Galileo number=ρ·σ³/μ⁴·g, ρ is a density of the liquid, σ is a surface tension of the liquid, and g is gravitational acceleration.

FIGS. 4A to 4D show various arrangements of bundles of the PV membrane elements 32. This is similar to those of a shell and tube heat exchanger. FIG. 4A shows a square straight arrangement, FIG. 4B shows a triangular alternate arrangement, FIG. 4C shows a square alternate arrangement, and FIG. 4D shows a triangular straight arrangement, respectively.

In order that the raw material side liquid dropping from the upper membrane element 32 can be received in a position right below the element 32 and successively sent to the lower positions, the necessary number of membrane elements 32 are disposed at intervals p in the vertical direction. Moreover, according to a treatment capacity, the plurality of membrane elements 32 are arranged in parallel at intervals p in the lateral direction and the membrane elements 32 for receiving the liquid flowing down from the lower ends of the membrane elements 32 are successively disposed in lower positions.

Whichever arrangement in those shown in FIGS. 4A to 4D is employed, the present invention is essentially effective. The alternating arrangement has a longer distance between the upper and lower membrane elements 32, and is advantageous in that the stirring and mixture at a portion where the lower membrane element 32 receives the liquid from the upper membrane element 32 are strong, and that it is easy to cancel the concentration boundary layer. However, if the module is inclined when it is installed, problems may occur in sending of the liquid dropped from the upper membrane element 32 to the lower membrane element 32, and it is necessary to pay careful attention in a construction step.

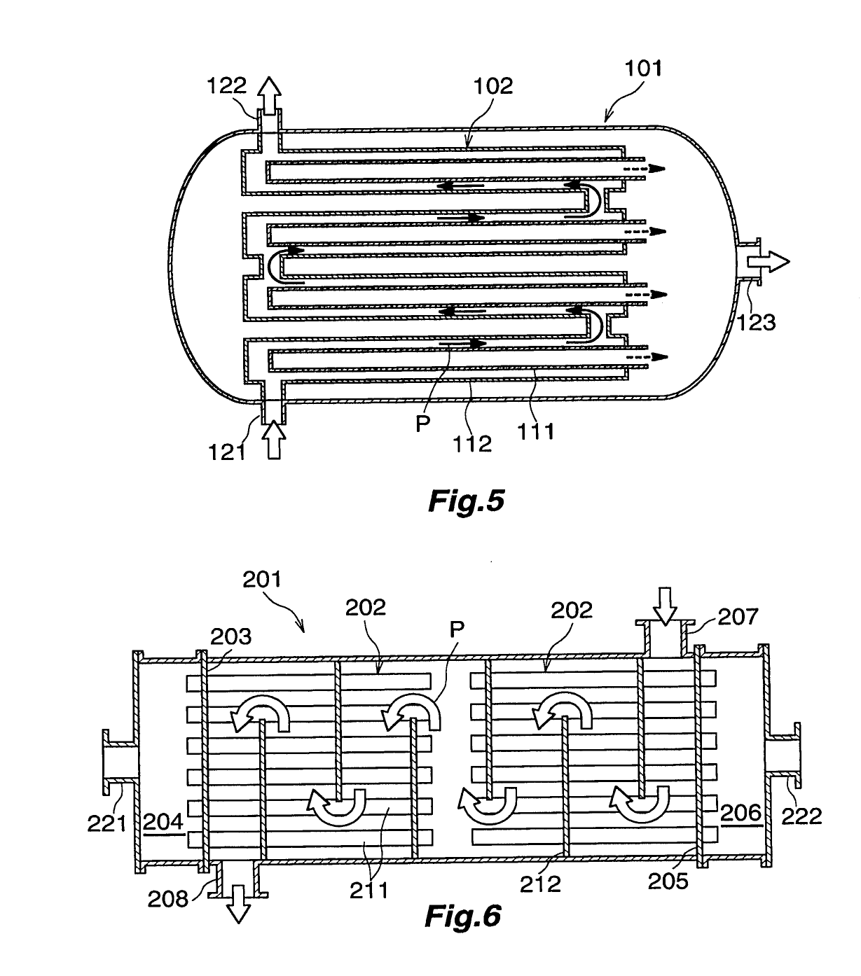

Effectiveness of the module according to the present invention was studied. Conditions were the same as those in the test of the double tube module described earlier with reference to FIG. 5. In other words, two tubular PV membrane elements were installed horizontally in upper and lower positions, and liquid was supplied to an outer face of the upper membrane element uniformly in a longitudinal direction to form a liquid membrane on the outer face of the membrane element. The lower membrane element was disposed right below the upper membrane element with a space of 10 mm from the upper membrane element. A liquid flow flowing down from a lower end of the upper membrane element was supplied to an upper end of the lower membrane element uniformly in the longitudinal direction. Performance confirmation was carried out by paying attention to the lower membrane element. The tubular PV membrane element was an A-type zeolite membrane having an outside shape of 17 mm and an effective length of 1 m. The supplied fluid was an aqueous solution of ethanol of an average concentration of 95 wt. % at the upper and lower ends of the second element. A flow rate of the supplied liquid was 100 L/h (which was supplied uniformly in the longitudinal direction of the upper element). An average temperature of the supplied liquid at the upper and lower ends of the second membrane element was maintained at about 75° C. Under these conditions, a Raynolds number of the liquid membrane formed on the outer surface of the lower membrane element was about 83. Operation pressure on the permeation side was 1 kPa (abs) similarly to the above-described comparative example.

Under these operation conditions, a flowing mode of the liquid moving from the upper membrane element to the lower membrane element was mainly the dropping mode, and the liquid column mode appeared occasionally. The liquid membrane formed on the surface of the membrane element was remarkably stable by the action of a high affinity of the surface of the A-type zeolite membrane and the aqueous solution of ethanol for each other and rupture of the liquid membrane was not observed. A calculated average thickness of the liquid membrane was about 0.18 mm, which means that an extremely thin liquid membrane was formed.

As a PV membrane permeation velocity under these conditions, a limit permeation flux dominating the concentration polarization was about 5.7 kg/m²·h. From these results, it was found that, in the liquid membrane module ingeniously utilizing the action of gravity, a design for reducing the influence of the concentration polarization without circulating the liquid can be made even when the amount of the supplied liquid is small.

Although comparison of the limit performance was carried out by using the test module using the two membrane elements herein, it is needless to say that a suitable design from viewpoints of throughput and product quality is necessary in a module design as a practical membrane separation device.

### INDUSTRIAL APPLICABILITY

The separation membrane module according to the present invention is suitable to anhydration of a mixed liquid of an organic solvent and water or a fluid such as vapor in an alcohol anhydration facility such as an ethanol manufacturing facility and a recycling facility of isopropyl alcohol (IPA).

### EXPLANATION OF REFERENCE NUMERALS

11 module main body
22, 24 separation vapor chamber
32 membrane element

1. (canceled)

2. A method for conducting a pervaporation membrane separation, comprising:
spraying a raw material liquid from above an uppermost membrane element of a membrane element row, the membrane element row comprising a plurality of external pressure tubular pervaporation membrane elements disposed horizontally in parallel at intervals in a vertical direction;
forming a falling liquid membrane on an outer surface of each of the membrane elements,
wherein the spraying and the forming are carried out in a module comprising a module main body container in which at least one of the membrane element row is disposed, an inside of each of the membrane elements being connected to a depressurizing system through a separation vapor chamber, and a spray for spraying the raw material liquid, and
Reynolds number (Re_{L}) of the falling liquid membrane satisfies 20≦Re_{L}≦200, where Re_{L} is defined as 4·m/μ, m is a half of a flow rate per unit length of a horizontal tube [kg/m·h], and μ is a viscosity of the liquid [kg/m·h].

3. The method of claim 2, wherein the raw material liquid dropped from a lower end of an upper membrane element turns into liquid drops and reaches an upper end of a lower membrane element.

4. The method of claim 2, wherein the module comprises at least one tube bundle comprising a plurality of the membrane element rows.

5. The method of claim 2,
wherein the module main body container has a long axis in a horizontal direction,
the module main body comprises a first end wall and a second end wall in the horizontal direction,
a first tube bundle is disposed on a first end wall side in the module main body container, and
a second tube bundle is disposed on a second end wall side in the module main body container.

6. The method of claim 5, wherein the module further comprises
a first vertical tube plate disposed near the first end wall in the module main body container, such that a first separation vapor chamber connectable to a first separation vapor exhaust pipe is formed between the first vertical tube plate and the first end wall,
a second vertical tube plate disposed near the second end wall in the module main body container, such that a second separation vapor chamber connectable to a second separation vapor exhaust pipe is formed between the second vertical tube plate and the second end wall, and
a first vertical support plate and a second vertical support plate provided opposite to each other at a center of the horizontal direction of the module main body container,
wherein each of the membrane elements in the first tube bundle is fixed between the first tube plate and the first support plate, one end of each of the membrane element in the first tube bundle is open and communicate with the first separation vapor chamber, and the other end is closed, and
each of the membrane element in the second tube bundle is fixed between the second tube plate and the second support plate, one end of each of the membrane element in the second tube bundle is open and communicate with the second separation vapor chamber, and the other end is closed.

7. The method of claim 6, wherein the module further comprises
a plurality of horizontal spray tubes extending in a longitudinal direction of the module main body container above the first and the second tube bundles,
wherein the plurality of spray tubes are arranged in a direction orthogonal to the longitudinal direction of the module main body container, each of the spray tubes comprises a plurality of downward spray holes arranged at intervals in the longitudinal direction, and each of the spray tubes is connected to a raw material liquid supply pipe.

8. The method of claim 6, wherein the module further comprises a pan below the first and the second tube bundles in the module main body container, the pan connected to a treatment liquid outlet pipe.

9. The method of claim 4, wherein, in the tube bundles, the membrane elements are disposed in series in the module main body.

10. The method of claim 2, wherein, in the tube bundles, the membrane elements are disposed in a triangular alternating arrangement or a square alternate arrangement.
